(19) United States
(12) Patent Application Publication
(10) Pub. No.: US 2008/0258896 A1
(43) Pub. Date: Oct. 23, 2008

(54) System for improving back end visibility and machine using same

(76) Inventors: Jason J. Stoller, Princeville, IL (US); Fu Yuet, Peoria, IL (US); Robert E. Richmond, Metamora, IL (US); E. Jorgen Akesson, Braine-l'Alleud (BE); Arve Opperud, Naperville, IL (US)

Correspondence Address: CATERPILLAR c/o LIELL, MCNEIL & HARPER, P.O. BOX 2417, 511 SOUTH MADISON STREET, BLOOMINGTON, IN, 47402-2417, US

(21) Appl. No.: 11/787,639

(22) Filed: Apr. 17, 2007

(51) Int. Cl. B60Q 1/00

(52) U.S. Cl. 340/459

(57) ABSTRACT

A machine includes a back end vision improvement system comprising a camera mounted for viewing an area behind a back end of the machine and a monitor mounted in an operator control station. The monitor includes a display having an initial display layout. The machine also includes an electronic control module (ECM) configured to sense a reverse position of a directional controller of the machine and change the display in response to the reverse position. The machine may also include a wiper system including a front wiper and a rear wiper. The ECM may be further configured to sense an activation of the front wiper and activate the rear wiper in response to the reverse position and the activation of the front wiper.

### TECHNICAL FIELD

The present disclosure relates generally to improving back end visibility for an operator of a machine, and more particularly to improving display options based on a reverse position of a directional controller of the machine during wet weather conditions.

### BACKGROUND

Although most vehicles are equipped with rear-view mirrors to assist with peripheral and rear views, some on-highway vehicles are also being provided with rear view cameras and monitors for displaying the rear views from the cameras. Utilizing these monitors effectively can reduce or eliminate “blind spots” at the rear of the vehicle that cannot be viewed using the available mirrors, and can allow the operator to more effectively maneuver the vehicle. Additionally, many vehicles are provided with rear wipers to improve the rear view through a rear window for the operator during inclement weather.

Off-highway machines present additional and, sometimes, greater rear view visibility problems, due to their large size and high profile. Additional “blind spots” and an increased number of directional changes present greater safety concerns with respect to these vehicles. While utilization of a camera and monitor system by operators of these machines would greatly reduce visibility concerns, operators of off-highway machines are typically already tasked with viewing one or more implements, such as a bucket of a wheel loader, and one or more devices providing performance or operational data in order to efficiently operate the machine.

U.S. Pat. No. 5,530,421 teaches a television system for a vehicle that provides the driver with rear and side views of the vehicle. Specifically, the system senses a condition of the vehicle, such as a reverse condition or a turn signal being actuated, and forces an appropriate camera view on the driver's monitor. If a reverse condition is sensed the view from the rear camera is forced on the monitor, or if the turn signal is actuated to the left or right, the view from the respective side camera is forced on the monitor. This reference does not, however, consider displaying additional information, such as operational information, or views in conjunction with the forced view.

U.S. Pat. No. 6,111,498 teaches an information system for a vehicle. A monitor of the information system displays a constant view from a rear or side camera and may include operational information overlying the rear or side view. Such operational information may include, for example, gas mileage, remaining fuel, and estimated time of arrival. The reference does not, however, contemplate altering the rear or side view with respect to the operational information based on the reverse direction of the vehicle.

The present disclosure is directed to one or more of the problems set forth above.

### SUMMARY OF THE INVENTION

In one aspect, a machine includes a back end vision improvement system comprising a camera mounted for viewing an area behind a back end of the machine, and a monitor mounted in an operator control station. The monitor includes a display having an initial display layout. The machine also includes an electronic control module (ECM) configured to sense a reverse position of a directional controller of the machine and change the display in response to the reverse position.

In another aspect, a method of operating a machine includes the step of providing a monitor for displaying a back end view provided by a camera. The method further includes the steps of shifting a directional controller of the machine to a reverse position, and changing the display with regard to the camera view in response to the reverse position. The method still further includes the steps of sensing an activation of a front wiper of the machine, and activating a rear wiper of the machine in response to the reverse position and the activation of the front wiper.

### BRIEF DESCRIPTION OF THE DRAWINGS

FIG. 1 is a side diagrammatic view of a machine having a system for improving rear view visibility according to the present disclosure;

FIG. 2 is a block diagram of a system for improving rear view visibility according to the present disclosure;

FIG. 3 is a flow chart of one embodiment of a method of controlling the display of a monitor and a rear wiper according to the present disclosure; and

FIG. 4 is an illustration of a display of a monitor according to the present disclosure.

### DETAILED DESCRIPTION

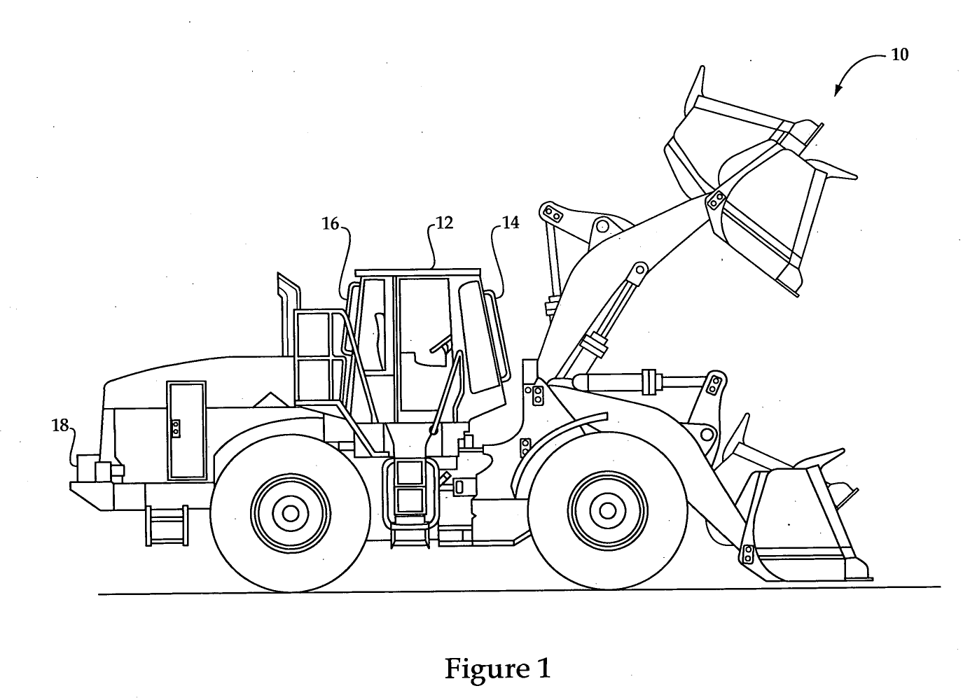

An exemplary embodiment of a machine 10 is shown generally in FIG. 1. The machine 10 may be an off-highway machine, such as, for example, a wheel loader, or any other machine utilizing a back end camera and a monitor to increase back end visibility. In the illustrated embodiment, wheel loader 10 comprises an operator control station 12 that may include a wiper system having a front wiper 14 and a rear wiper 16. Each of the front wiper 14 and rear wiper 16 may be set to at least one operating speed via one or more manual controllers located in the operator control station 12. The operator control station 12 may additionally house a monitor (not shown) for displaying operational information and a view from a back end camera 18. The back end camera 18 may be mounted at a back end of the wheel loader 10, as shown in FIG. 1. Alternatively, the back end camera 18 may be mounted at any location on the wheel loader 10 that provides a view of an area proximate the back end of the wheel loader. The wheel loader 10 may also include one or more implements, such as, for example, bucket 20.

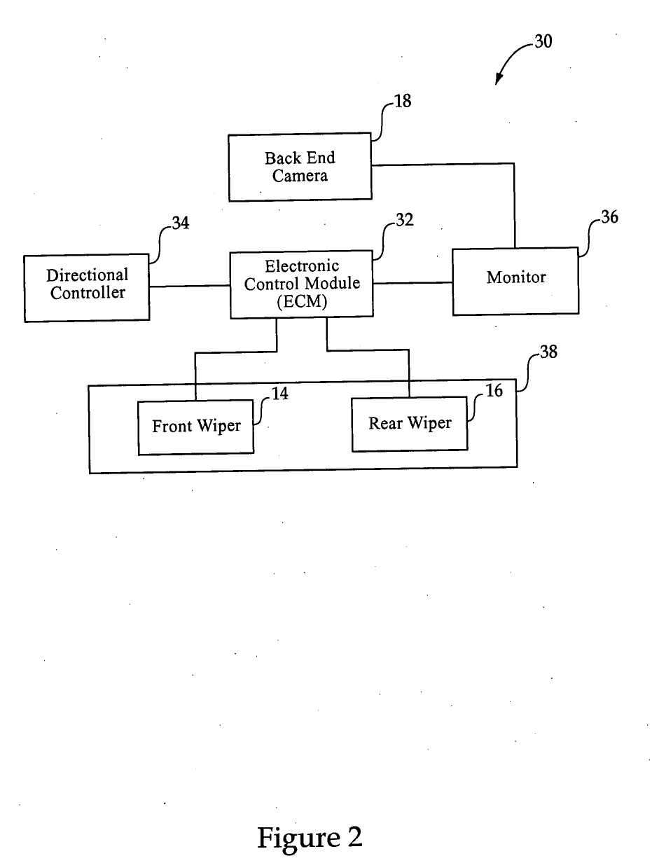

FIG. 2 shows a block diagram of a system for improving rear view visibility for an operator of wheel loader 10. The system, shown generally at 30, includes an electronic control module (ECM) 32. The ECM 32 is of standard design and generally includes a processor, such as, for example, a central processing unit (CPU), a memory, and an input/output circuit that facilitates communication internal and external to the ECM 32. The CPU controls operation of the ECM 32 by executing operating instructions, such as, for example, programming code stored in memory, wherein operations may be initiated internally or externally to the ECM 32. A control scheme may be utilized that monitors outputs of systems or devices, such as, for example, sensors, actuators, or control units, via the input/output circuit to control inputs to various other systems or devices.

The memory may comprise temporary storage areas, such as, for example, cache, virtual memory, or random access memory (RAM), or permanent storage areas, such as, for example, read-only memory (ROM), removable drives, network/internet storage, hard drives, flash memory, memory sticks, or any other known volatile or non-volatile data storage devices located internally or externally to the ECM 32. One skilled in the art will appreciate that any computer-based system utilizing similar components is suitable for use with the present disclosure.

The ECM 32 receives input from a directional controller 34. Directional controller 34 may be an operator input device located in the operator control station 12, or a transmission, or any other assembly of gears and parts that controls power transmitted from an engine to a driving axle of the wheel loader 10. One or more sensors may be provided to sense various positions of the directional controller 34, such as, for example, REVERSE, FORWARD, STATIONARY, etc. Based on a sensed position of the directional controller 34, the ECM 32 may change the display provided on a monitor 36, located in the operator control station 12. The monitor 36 may display operational or performance information that is useful to the operator of the wheel loader 10. Such information may include, for example, information regarding gauges, speed, temperatures, warnings, date/time, and payload. The monitor 36 may also display a view from the back end camera 18.

The ECM 18 may also be in communication with a wiper system 38. The wiper system includes front wiper 14 and rear wiper 16. Sensors within the wiper system 38 may sense operating positions or speeds of the wipers 14 and 16 and communicate the sensed positions to the ECM 18.

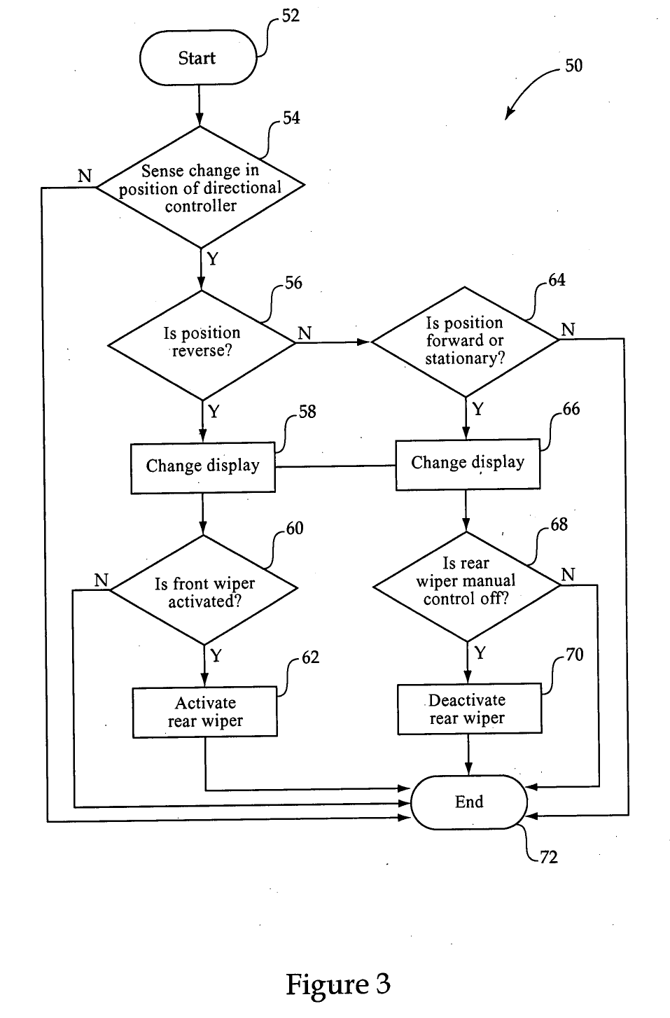

Turning to FIG. 3, there is shown a flow chart 50 representing an exemplary method of controlling the system 30 of FIG. 2. The method may be implemented by the ECM 32 of the system 30. The method begins at a START, Box 52. From Box 52, the method may proceed to Box 54, which includes the step of determining whether there has been a change in position of the directional controller 34 of the wheel loader 10. If there has not been a change in the position, the method proceeds to an END, Box 72.

Additionally, at Box 54, the method may include sensing an imminent REVERSE position of the directional controller 34 by evaluating at least one and possibly a combination of a machine motion and a bucket configuration. For example, a machine motion that may indicate an imminent REVERSE position may include the machine 10 rapidly decreasing in speed. A bucket configuration that may indicate an imminent reverse position may include a specific bucket elevation or rotation that may indicate that a wheel loader 10 is carrying a load in the bucket 20.

If there has been a change in the position, the method determines if the current position is a REVERSE position or an imminent REVERSE position, at Box 56. If the current position of the directional controller 34 is a REVERSE position or imminent REVERSE position, the display of the monitor 36 is changed, at Box 58. The display may be changed to include an enlarged view from the back end camera 18.

After the display is changed at Box 58, the method proceeds to Box 60, where it is determined whether or not the front wiper 14 is activated and, if so, at what speed setting the front wiper is operating. If the front wiper 14 is activated, the method proceeds to Box 62 where the rear wiper 16 is activated. The rear wiper 16 may be activated to the same speed selection or setting as the front wiper 14. If, however, the front wiper 14 is not activated, the method proceeds to the END, Box 72.

If a determination was made, at Box 56, that the current position of the directional controller 34 is not REVERSE, the method proceeds to Box 64. At Box 64, the method determines if the current position is FORWARD or STATIONARY. If the current position of the directional controller 34 is FORWARD or STATIONARY, the display of the monitor 36 is changed, at Box 66. The display may be changed to include an enlarged view of operational or performance information.

After the display is changed at Box 66, the method proceeds to Box 68, where it is determined whether or not a manual control for the rear wiper 16 is in an OFF position. If the manual control is in an OFF position, the method proceeds to Box 70 where the rear wiper 16 is deactivated. If, however, the manual control is in an ON position, the method proceeds to the END, Box 72.

### INDUSTRIAL APPLICABILITY

A wheel loader 10 generally includes an operator control station 12 that may include a wiper system having a front wiper 14 and a rear wiper 16. The operator control station 12 may additionally house a monitor for displaying operational information and a view from a back end camera 18. The back end camera 18 may be mounted at a back end of the wheel loader 10, as shown in FIG. 1. The wheel loader 10 may also include one or more implements, such as, for example, bucket 20.

Wheel loader 10 and other off-highway machines present rear view visibility problems, due to their large size and high profile. While utilization of a camera and monitor system by operators of these machines would greatly reduce visibility concerns, operators of off-highway machines are typically already tasked with viewing one or more devices providing performance or operational data in order to efficiently operate the machine. The method of controlling the display of a monitor that also includes operational information according to the present disclosure may be implemented to optimize rear view visibility for an operator of wheel loader 10.

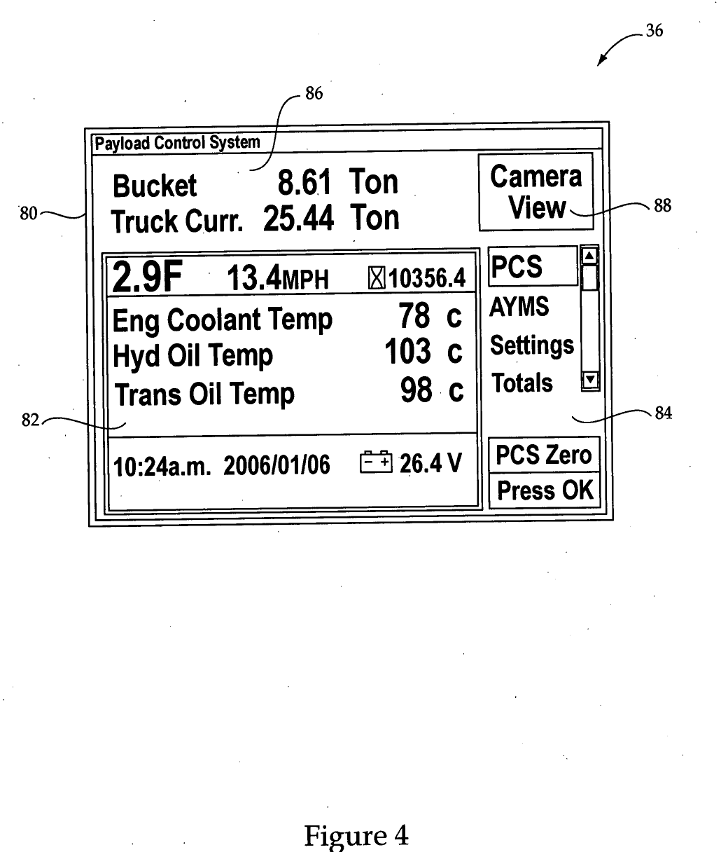

Turning to FIG. 4, one example of a display 80 of the monitor 36 is shown. The display 80 of FIG. 4 may be provided to an operator of the wheel loader 10 when the method of FIG. 3 determines the directional controller 34 is in a FORWARD or STATIONARY position. The display 80 may include a first operational information area 82, which may include, for example, information regarding gauges, speed, temperatures, warnings, date/time, and payload. The display 80 may further include a menu area 84 for providing a menu from which the operator may select the operational or performance data to be displayed in a second operational information area 86. An interactive keypad or touchscreen, or any other similar device, may be used to facilitate navigation of the menu area 84. The menu area 84 may refer to various sets of operational information that may be selected based on an operator's preference. For example, if an operator chooses to view payload data, he or she may select such a reference from the menu area 84 and all relevant payload data for wheel loader 10 will be displayed in the second operational information area 86. In addition, the display 80 may be configured to include a small view 88 from the back end camera 18.

Alternatively, when the method of FIG. 3 determines the directional controller 34 is in a REVERSE position or an imminent REVERSE position, the view from the back end camera 18 may be displayed in the first operational information area 82. The information that was displayed in the first operational information area may now be displayed where a small view from the back end camera 8 was shown at 88.

While operating in a FORWARD or STATIONARY position, the method of FIG. 3 provides the operator of wheel loader 10 with an enlarged display of operational information, as shown in FIG. 4. When the wheel loader 10 is changed to a REVERSE position, or the ECM 32 senses an imminent REVERSE position of the directional controller 34, the method of FIG. 3 provides the operator with an enlarged view from the back end camera 18, while still providing necessary operational information. An imminent REVERSE position may be determined by evaluating normal operating conditions of the wheel loader 10. For example, it may be presumed that after the wheel loader 10 has approached a pile, accepted a load in the bucket 20, and lifted the loaded bucket, an operator will place the wheel loader in a REVERSE position soon thereafter to transport the load. It may also be presumed that after the wheel loader 10 has approached a dumping area and emptied the load carried in the bucket 20 an operator will place the wheel loader in a REVERSE position soon thereafter. Therefore, evaluating the machine motion and bucket configuration may be useful in anticipating an imminent REVERSE position of the wheel loader 10. Although one arrangement is shown for the display 80, one skilled in the art will appreciate that alternate arrangements may be provided based on operator preference.

The present disclosure is advantageous because it provides an operator of a machine greater rear view visibility in normal or inclement weather, while still providing the operator with the operational or performance information necessary to operate the machine at maximum efficiency. Optimum displays are provided automatically based on driving conditions of the machine.

It should be understood that the above description is intended for illustrative purposes only, and is not intended to limit the scope of the present invention in any way. Thus, those skilled in the art will appreciate that other aspects of the invention can be obtained from a study of the drawings, the disclosure and the appended claims.

What is claimed is:

1. A machine, comprising:
a back end vision improvement system comprising a camera mounted for viewing an area behind a back end of the machine and a monitor mounted in an operator control station, wherein the monitor includes a display having an initial display layout; and
an electronic control module configured to sense a reverse position of a directional controller of the machine and change the display in response to the reverse position.

2. The machine of claim 1, further including:
a wiper system including a front wiper and a rear wiper; and
the electronic control module further configured to sense an activation of the front wiper and activate the rear wiper in response to the reverse position and the activation of the front wiper.

3. The machine of claim 1, wherein the initial display layout includes the camera view occupying a fractional portion of the display.

4. The machine of claim 1, wherein the monitor is configured to simultaneously display operational information and the camera view.

5. The machine of claim 4, wherein the electronic control module is further configured to alter a position of the operational information displayed on the monitor.

6. The machine of claim 1, wherein the electronic control module is further configured to enlarge the camera view displayed on the monitor.

7. The machine of claim 1, wherein the electronic control module is further configured to alter a position of the camera view displayed on the monitor.

8. The machine of claim 1, wherein the electronic control module is further configured to:
sense an imminent reverse position of the directional controller by evaluating at least one of a machine motion and a bucket configuration; and
change the display in response to the imminent reverse position.

9. The machine of claim 1, wherein the electronic control module is further configured to:
sense a forward or stationary position of the directional controller; and
return the display to the initial display layout in response to the forward or stationary position.

10. A method of operating a machine, comprising:
providing a monitor for displaying a back end view provided by a camera;
shifting a directional controller of the machine to a reverse position;
changing the display with regard to the camera view in response to the reverse position;
sensing an activation of a front wiper of the machine; and
activating a rear wiper of the machine in response to the reverse position and the activation of the front wiper.

11. The method of claim 10, wherein the providing step further includes displaying the camera view on a fractional portion of the display.

12. The method of claim 10, wherein the providing step further includes simultaneously displaying operational information and the camera view.

13. The method of claim 12, further including:
altering a position of the operational information displayed on the monitor in response to the reverse position.

14. The method of claim 10, wherein the changing step includes:
enlarging the camera view displayed on the monitor.

15. The method of claim 10, wherein the changing step includes:
altering a position of the camera view displayed on the monitor.

16. The method of claim 10, further including:
sensing an imminent reverse position of the directional controller by evaluating at least one of a machine motion and a bucket configuration;
changing the display in response to the imminent reverse position; and
activating the rear wiper in response to the imminent reverse position and the activation of the front wiper.

17. The method of claim 10, further including:
shifting a directional controller of the machine to a forward or stationary position;
changing the display with regard to the camera view in response to the forward or stationary position; and
deactivating the rear wiper in response to the forward or stationary position if a manual controller of the rear wiper is in an off position.

18. The method of claim 17, wherein the changing step includes:
reducing the camera view displayed on the monitor.

19. The method of claim 17, wherein the changing step includes:
altering a position of the camera view displayed on the monitor.

20. The method of claim 10, further including:
activating the rear wiper of the machine in response to an operator command.
